(19) United States
(12) Patent Application Publication
(10) Pub. No.: US 2023/0022406 A1
(43) Pub. Date: Jan. 26, 2023

(54) PORTAL GEAR HUB WITH OIL COOLING LOOP

(71) Applicant: Super ATV, LLC, Madison, IN (US)

(72) Inventors: Chris Shelton, Madison, IN (US); Jason Stewart, Harvest, AL (US)

(21) Appl. No.: 17/411,112

(22) Filed: Aug. 25, 2021

Related U.S. Application Data
(63) Continuation of application No. 17/382,525, filed on Jul. 22, 2021.

(51) Int. Cl. F16H 57/04; F16H 57/02

(52) U.S. Cl. CPC F16H 57/0417; F16H 57/02; F16H 57/0436; F16H 57/0404; F16H 2057/02056

(57) ABSTRACT

A portal gear box assembly for an all-terrain vehicle includes: a portal gear box housing a set of gears and linking an axle to an output shaft; a lubricating oil contained in the gear box; and a fluid circulation loop that circulates a cooling fluid to a cooling location outside the gear box. The cooling fluid may be a lubricating oil. The fluid circulation loop may include a pump and/or a filter. The cooling location may pass the fluid through a structure such as a radiator or other cooler. The circulation loop and/or any radiator/cooler, filter, or pump contained therein, may serve a single portal gear box, or may serve two or more portal gear box assemblies.

### REFERENCE TO RELATED APPLICATIONS

This application claims priority from U.S. patent application Ser. No. 17/382,525, filed Jul. 22, 2021; the entire contents of the prior application being hereby incorporated herein by reference.

### FIELD OF THE INVENTION

The present invention relates generally to portal wheel ends for lifting the wheels of an off road vehicle such as an all-terrain vehicle (ATV) or a utility task vehicle (UTV), and more particularly to gear-reducing portal gear boxes.

### BACKGROUND OF THE INVENTION

Portal boxes are used by ATV and UTV enthusiasts to raise an off-road vehicle higher above the ground so that larger tires can be run on the vehicle. In addition, since larger diameter tires cover a greater distance with each rotation, portal box assemblies typically include gear reduction so that a single rotation of the vehicle power axle results in a slightly lesser rotation of the output axle. Further, the extra length provided by the output axle also typically allows the assembly to widen the wheelbase of the vehicle.

Portal gear boxes typically are sealed to contain a fluid lubricant effective to lubricate the gears as the gears spin within the housing. Vigorous use may cause the gears and their lubricant to heat, and that heating may reduce the effectiveness of the lubricant and cause pressure to build up within the housing.

A need therefore exists for materials and methods for reducing portal gear box heating, and for avoiding, reducing, and/or relieving resulting pressure. The present invention addresses that need.

### SUMMARY OF THE INVENTION

In one aspect of the invention there is provided a portal gear box system for an all-terrain vehicle or a utility task vehicle. The system may comprise:

a) a sealed portal gear box housing having an interior housing space defined by a rear wall, a front wall, and a side wall,

wherein the rear wall includes a vehicle axle opening effective to receive the end of an axle of an all-terrain vehicle or a utility task vehicle, and

wherein the front wall includes an output shaft opening effective to receive the end of an output shaft effective to power a vehicle wheel;

b) a set of gears housed in said housing and effective for linking an axle received in the vehicle axle opening to an output shaft received in the output shaft opening;

c) an output shaft operably connectable via said linking mechanism to an axle received in the vehicle axle receptacle, and effective to rotate upon rotation of the stock axle;

d) a fluid circulation loop effective to circulate a cooling fluid from a fluid output location to a fluid input location, with the fluid circulation loop being substantially external to the housing; and

e) a cooling fluid contained in the fluid circulation loop and effective to cool the temperature of components contained in the portal gear box.

In another aspect of the invention there is provided a portal gear box assembly for an all-terrain vehicle or a utility task vehicle, comprising:

a) a portal gear box housing a set of gears effective for linking an axle received in the vehicle axle opening to an output shaft received in the output shaft opening;

b) a lubricating oil contained in the portal gear box; and

c) a fluid circulation loop effective to circulate a cooling fluid from a fluid output opening to a fluid input opening, with the fluid circulation loop being substantially external to the portal gear box.

In some preferred embodiments of either or both of these aspects the cooling fluid is additionally effective to lubricate components contained in the portal gear box, and thus to improve the life and/or functioning of the components.

In some preferred embodiments of either or both of these aspects the cooling and lubricating fluid is oil.

In some preferred embodiments of either or both of these aspects the fluid circulation loop includes a pump.

In some preferred embodiments of either or both of these aspects the fluid circulation loop includes a filter effective to filter the circulating fluid.

In some preferred embodiments of either or both of these aspects the fluid circulation loop passes the fluid through a radiator/cooler effective to assist with the cooling of the fluid in the fluid circulation loop.

In some preferred embodiments of either or both of these aspects the fluid circulation loop is effective to maintain the temperature of oil contained therein within the optimum temperature range of the oil.

In some preferred embodiments of either or both of these aspects the fluid circulation loop circulates cooling fluid between two or more portal gear box assemblies.

In some preferred embodiments of either or both of these aspects the cooling fluid is caused to circulate through the fluid circulation loop by a pumping action caused by the rotation of one or more gears in the set of gears.

### BRIEF DESCRIPTION OF THE DRAWINGS

FIG. 1 is a schematic figure showing one embodiment of the present invention.

FIG. 2 is a schematic figure showing another embodiment of the present invention.

FIG. 3 is a schematic figure showing another embodiment of the present invention.

FIG. 4 shows an embodiment of the present invention where the cooling fluid is caused to circulate through the fluid circulation loop by a pumping action caused by the rotation of one or more gears in the set of gears.

### DESCRIPTION OF THE PREFERRED EMBODIMENTS

For the purposes of promoting an understanding of the principles of the invention, reference will now be made to certain embodiments and specific language will be used to describe the same. It will nevertheless be understood that no limitation of the scope of the invention is thereby intended, such alterations and further modifications in the described device, and such further applications of the principles of the invention as illustrated therein, being contemplated as would normally occur to one skilled in the art to which the invention relates.

As indicated above, one aspect of the present invention relates to a portal gear box system for an all-terrain vehicle or a utility task vehicle. The system may comprise:

a) a sealed portal gear box housing having an interior housing space defined by a rear wall, a front wall, and a side wall,
wherein the rear wall includes a vehicle axle opening effective to receive the end of an axle of an all-terrain vehicle or a utility task vehicle, and
wherein the front wall includes an output shaft opening effective to receive the end of an output shaft effective to power a vehicle wheel;

b) a set of gears housed in said housing and effective for linking an axle received in the vehicle axle opening to an output shaft received in the output shaft opening;

c) an output shaft operably connectable via said linking mechanism to an axle received in the vehicle axle receptacle, and effective to rotate upon rotation of the stock axle;

d) a fluid circulation loop effective to circulate a cooling fluid from a fluid output location to a fluid input location, with the fluid circulation loop being substantially external to the housing; and

e) a cooling fluid contained in the fluid circulation loop and effective to cool the temperature of components contained in the portal gear box.

Portal gear boxes are well known to the art, and typically comprise a rear wall, a front wall, and a side wall. The walls define an interior housing space. The rear wall typically includes a vehicle axle opening effective to receive the end of an axle of an all-terrain vehicle or a utility task vehicle, and the front wall typically includes an output shaft opening effective to receive the end of an output shaft effective to power a vehicle wheel. A set of gears is housed in the housing, and is effective for linking an axle received in the vehicle axle opening to an output shaft received in the output shaft opening. The input opening is typically located above the output shaft, and the gears are sized to provide an appropriate gear reduction. This arrangement allows the user to run larger wheels by raising the vehicle and accounting for the differences in rotational axle speed that is required. Such assemblies are typically referred to as portal gear lifts, portal gear hubs, portal gear boxes, portal gear lift boxes, or some other similar name, and for the purposes of this disclosure any such similar name may be used to refer to assemblies of this type.

As with many mechanical systems, lubrication is desirable, so the interior housing space is substantially sealed to allow a lubricating fluid to be contained therein. However, and particularly in harsh environments, the lubricating fluid may become overheated, thus reducing its useful life and performance.

The present invention provides effective cooling of the interior of a portal lift gear box and the components contained therein by circulating a cooling fluid through the box.

The circulating cooling fluid is preferably a lubricating fluid, such as a natural or synthetic lubricating oil, that additionally lubricates the portal gear box components. However, in some embodiments the cooling fluid may be another fluid, such as water, ethylene glycol, or propylene, or the like, and may contain protection additives.

The fluid is contained in a circulation loop that passes outside the outside the box, where the cooling fluid is cooled before being returned to the box. The cooling fluid circulation loop may function to circulate cooling fluid to only one portal gear box, or it may circulate cooling fluid to two or more portal gear box assemblies.

The cooling fluid may be caused to circulate through the circulation loop by the power of a pump. The pump may be external to the box, or components within the box may be used to provide the pumping action.

The cooling fluid may be cooled by passing through a radiator or some other cooling structure. The radiator or other cooling structure may cool the fluid for one or more circulation loops.

The cooling fluid may be passed through a filter to remove contaminating particles from the fluid. The filter may filter the fluid for one or more circulation loops.

The cooling fluid may exit the portal gear box through an output structure such as an exit port, and may return to the portal gear box through an input structure such as an input/entrance port.

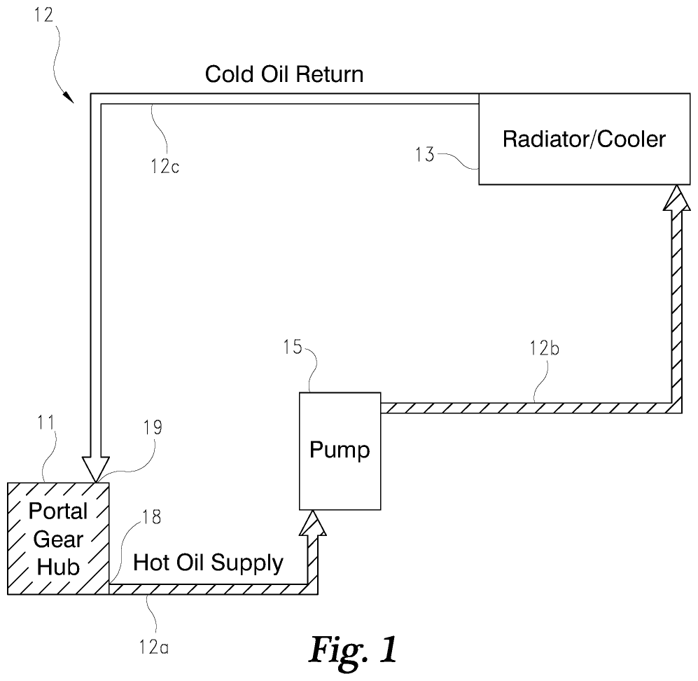

Referring now to the drawings, FIG. 1 is a schematic figure showing one embodiment of the present invention. In this embodiment a portal gear box cooling assembly comprises a portal gear hub 11 with a cooling fluid circulation loop 12, comprising a portion 12a that circulates fluid from output 18 to pump 15, a portion 12b that circulates the cooling fluid from pump 15 to radiator/cooler 13, and a portion 12c that circulates the cooling fluid from radiator/cooler 13 back to an input 19 of portal gear hub 11.

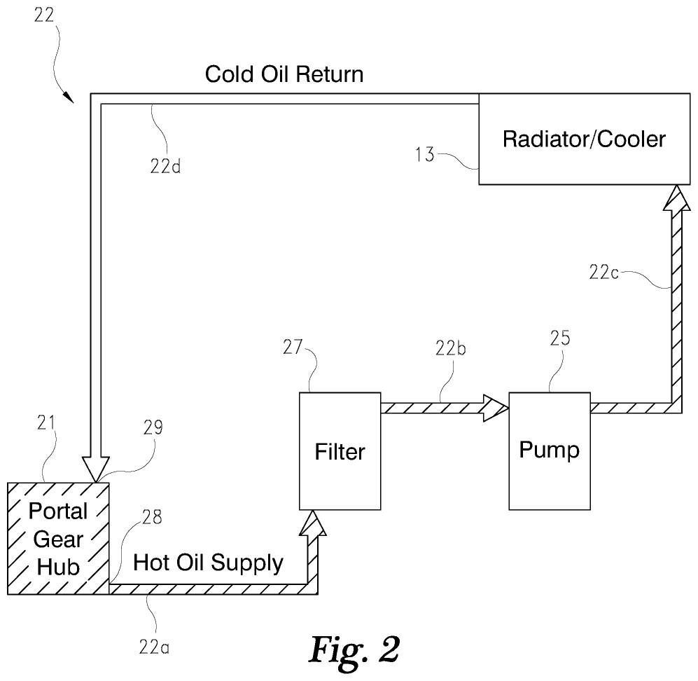

FIG. 2 is a schematic figure showing another embodiment of the present invention. In this embodiment a portal gear box cooling assembly comprises a portal gear hub 21 with a cooling fluid circulation loop 22, comprising a portion 22a that circulates fluid from output 28 to filter 27, pump 15, a portion 12b that circulates the cooling fluid from filter 27 to pump 25, a portion 12c that circulates the cooling fluid from pump 25 to radiator/cooler 23, and a portion 22d that circulates the cooling fluid from radiator/cooler 23 back to an input 29 of portal gear hub 21.

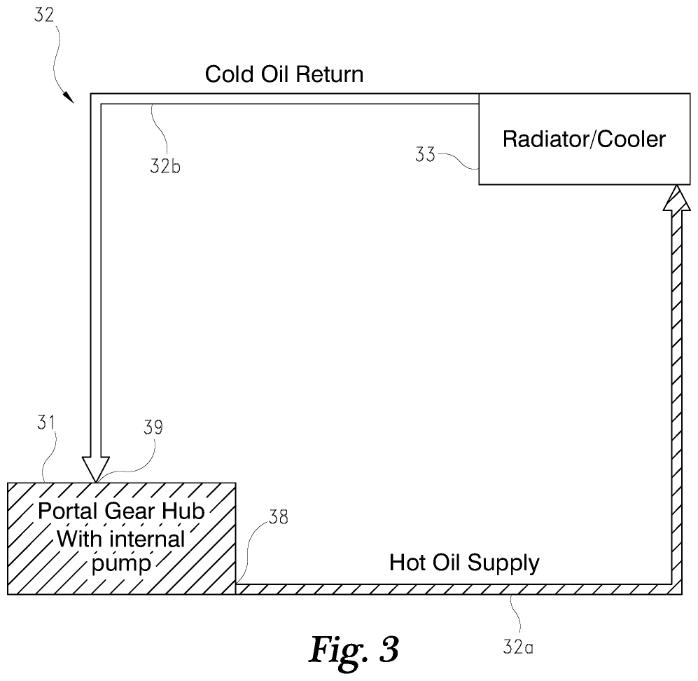

FIG. 3 is a schematic figure showing another embodiment of the present invention. In this embodiment a portal gear box cooling assembly comprises a portal gear hub 31 with a cooling fluid circulation loop 32, comprising a portion 32a that circulates fluid from output 38 to radiator/cooler 33, and a portion 32b that circulates the cooling fluid from radiator/cooler 33 back to an input 39 of portal gear hub 31.

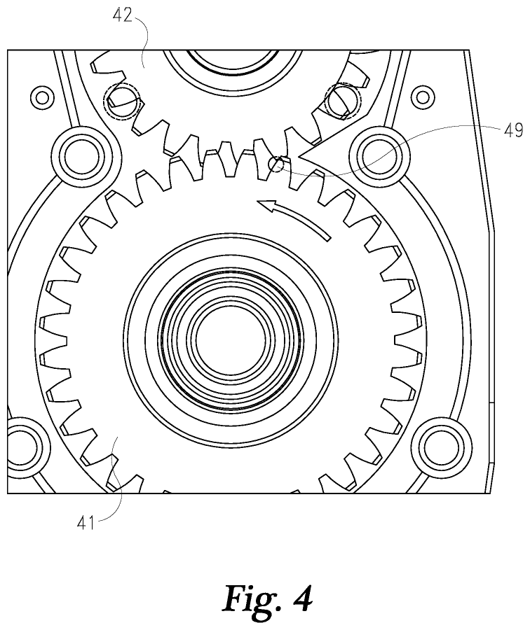

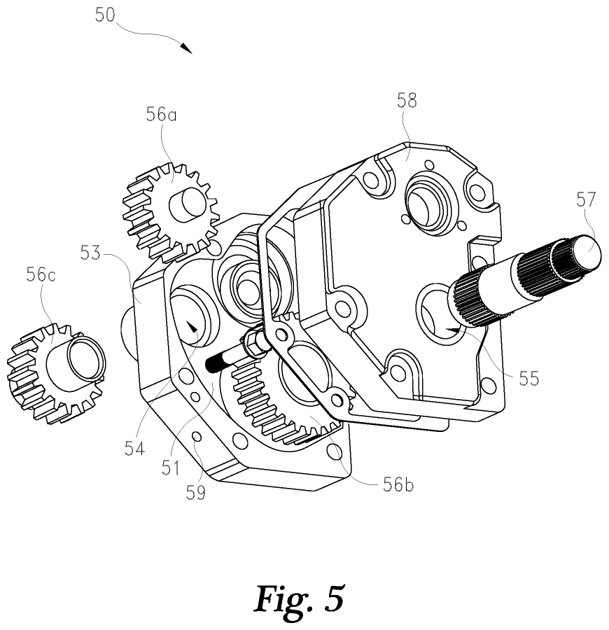

FIG. 4 shows an embodiment of the present invention where the cooling fluid is caused to circulate through the fluid circulation loop by a pumping action caused by the rotation of one or more gears in the set of gears. In this embodiment a portal gear box cooling assembly comprises gear 41 and gear 42 that mate to push oil out of oil exit port 49 into an oil/cooling fluid circulation loop (not illustrated).

While the invention has been illustrated and described in detail in the foregoing description and drawings, the same are to be considered as illustrative and not restrictive in character, it being understood that only certain preferred embodiments have been shown and described, and that all changes and modifications that come within the spirit of the invention are desired to be protected.

Additionally, it is to be appreciated that the present invention may comprise or consist essentially of any or all of the described ingredients in their disclosed amounts, and that any or all of the ingredients, amounts, features, elements, and/or embodiments disclosed herein may be combined with any or all of the other ingredients, amounts, features, elements, and/or embodiments disclosed herein to provide an invention that comprises or consists essentially of such ingredients, amounts, features, elements, and/or embodiments.

The grammatical device “and/or” (such as in “A and/or B”) is used in this disclosure to mean A alone, or B alone, or both A and B. Additionally, the term “substantially perpendicular” means within 5° of perpendicular, and the term “substantially forward” (or rearward) of perpendicular means at least 10° forward (or rearward) of perpendicular.

1. A portal gear box assembly for an all-terrain vehicle or a utility task vehicle, the assembly comprising:
a) a sealed portal gear box housing having an interior housing space defined by a rear wall, a front wall, and a side wall,
wherein the rear wall includes a vehicle axle opening effective to receive the end of an axle of the all-terrain vehicle or the utility task vehicle, and
wherein the front wall includes an output shaft opening effective to receive the end of an output shaft effective to power a vehicle wheel;
b) a set of linking gears housed in said housing and effective for linking the axle received in the vehicle axle opening to the output shaft received in the output shaft opening;
c) an output shaft operably connectable via said linking gears to an axle received in the vehicle axle opening, and effective to rotate upon rotation of the stock axle;
d) a fluid circulation loop effective to circulate a cooling fluid from a fluid output location to a fluid input location, with the fluid circulation loop being substantially external to the portal gear box housing; and
e) a cooling fluid contained in the fluid circulation loop and effective to cool the temperature of components contained in the portal gear box housing.

2. A portal gear box assembly according to claim 1 wherein the cooling fluid is additionally effective to lubricate the components contained in the portal gear box, and thus to improve the life and/or functioning of the components.

3. A portal gear box assembly according to claim 2 wherein the cooling and lubricating fluid is oil.

4. A portal gear box assembly according to claim 1 wherein the fluid circulation loop includes a pump.

5. A portal gear box assembly according to claim 1 wherein the fluid circulation loop includes a filter effective to filter the circulating cooling fluid.

6. A portal gear box assembly according to claim 1 wherein the fluid circulation loop passes the cooling fluid through a radiator/cooler effective to assist with the cooling of the cooling fluid in the fluid circulation loop.

7. A portal gear box assembly according to claim 3 wherein the fluid circulation loop is effective to maintain the temperature of oil contained therein within the optimum temperature range of the oil.

8. A portal gear box assembly according to claim 1 wherein the fluid circulation loop circulates the cooling fluid between two or more portal gear box assemblies.

9. A portal gear box assembly according to claim 1 wherein the cooling fluid is caused to circulate through the fluid circulation loop by a pumping action caused by the rotation of one or more gears in the set of gears.

10. A portal gear box assembly for an all-terrain vehicle or a utility task vehicle, the assembly comprising:
a) a portal gear box housing a set of gears effective for linking an axle received in an vehicle axle opening to an output shaft received in the output shaft opening;
b) a lubricating oil contained in the portal gear box; and
c) a fluid circulation loop effective to circulate the lubricating oil from a fluid output opening to a fluid input opening, with the fluid circulation loop being substantially external to the portal gear box.

11. A portal gear box assembly according to claim 10 wherein the lubricating oil is additionally effective to lubricate components contained in the portal gear box, and thus to improve the life and/or functioning of the components.

12. (canceled)

13. A portal gear box assembly according to claim 10 wherein the fluid circulation loop includes a pump.

14. A portal gear box assembly according to claim 10 wherein the fluid circulation loop includes a filter effective to filter the circulating fluid lubricating oil.

15. A portal gear box assembly according to claim 10 wherein the fluid circulation loop passes the fluid through a radiator/cooler effective to assist with the cooling of the lubricating oil in the fluid circulation loop.

16. A portal gear box assembly according to claim 10 wherein the fluid circulation loop is effective to maintain the temperature of the lubricating oil contained therein within the optimum temperature range of the oil.

17. A portal gear box assembly according to claim 10 wherein the fluid circulation loop circulates the lubricating oil between two or more portal gear box assemblies.

18. A portal gear box assembly according to claim 10 wherein cooling fluid is caused to circulate through the fluid circulation loop by a pumping action caused by the rotation of one or more gears in the set of gears.

19. A portal gear lift system for an all-terrain vehicle or a utility task vehicle, the system comprising:
a) a first sealed portal gear lift box, comprising:
i) a sealed housing having an interior housing space defined by a rear wall, a front wall, and a side wall,
wherein the rear wall includes an input shaft opening effective to receive the end of an axle of an all-terrain vehicle or a utility task vehicle, and
wherein the front wall includes an output shaft opening effective to receive the end of an output shaft effective to power a vehicle wheel, and
wherein the housing includes:
1) an oil output effective to allow oil contained in the sealed housing to exit the housing; and
2) an oil input effective to allow oil outside the sealed housing to enter the housing;
ii) an axle disposed in the input shaft opening;
iii) an output shaft disposed in the output shaft opening and vertically offset from the axle, thus lifting the vehicle relative to its position without the portal gear box;
iv) a set of linking gears housed in the housing and effective for linking the axle disposed in the input shaft opening to the output shaft disposed in the output shaft opening, thus operably connecting the axle to the output shaft set to cause the output shaft to rotate upon rotation of the axle;
v) a lubricating oil contained in the portal gear box;
b) a second sealed portal gear lift box, comprising:
i) a sealed housing having an interior housing space defined by a rear wall, a front wall, and a side wall,
wherein the rear wall includes an input shaft opening effective to receive the end of an axle of an all-terrain vehicle or a utility task vehicle, and
wherein the front wall includes an output shaft opening effective to receive the end of an output shaft effective to power a vehicle wheel, and
wherein the housing includes:
1) an oil output effective to allow oil contained in the sealed housing to exit the housing; and
2) an oil input effective to allow oil outside the sealed housing to enter the housing;
ii) an axle disposed in the input shaft opening;
iii) an output shaft disposed in the output shaft opening and vertically offset from the axle, thus lifting the vehicle relative to its position without the portal gear box;
iv) a set of linking gears housed in the housing and effective for linking the axle disposed in the input shaft opening to the output shaft disposed in the output shaft opening, thus operably connecting the axle to the output shaft set to cause the output shaft to rotate upon rotation of the axle;
v) a lubricating oil contained in the portal gear box;
c) an oil circulation loop effective to circulate the lubricating oil from the oil output of the first sealed portal gear box to the oil input location of the second sealed portal gear box, and thereafter from the oil output of the second sealed portal gear box to the oil input location of the first sealed portal gear box;
wherein the oil circulation loop is substantially external to the sealed housings of the first sealed portal gear box and the second sealed portal gear box.

20. A portal gear lift system according to claim 19 wherein the oil is caused to circulate through the oil circulation loop by a pumping action caused by the rotation of one or more of the linking gears.
